(19) United States
(12) Patent Application Publication
(10) Pub. No.: US 2025/0135823 A1
(43) Pub. Date: May 1, 2025

(54) DUAL VOLUME AIR SPRING

(71) Applicant: Sarika BENIWAL, Shamli (IN)

(72) Inventor: Sarika BENIWAL, Shamli (IN)

(21) Appl. No.: 18/836,717

(22) PCT Filed: Feb. 9, 2023
(86) PCT No.: PCT/IB2023/051157

§ 371 Date: Aug. 7, 2024

(30) Foreign Application Priority Data
Feb. 10, 2022 (IN) 202211007021

(51) Int. Cl. B60G 11/27; B60G 17/052; F16F 9/04

(52) U.S. Cl. CPC B60G 11/27; B60G 17/0521; F16F 9/049; B60G 2202/152; B60G 2202/314; B60G 2206/42

(57) ABSTRACT

A dual volume air spring assembly comprising a first member, a second member, a deflectable diaphragm configured to at least partially defines a primary air volume chamber, and also at least partially defines a secondary air volume chamber. The deflectable diaphragm deflects from a first position to a second position due to a change of air pressure difference created between two chambers. In another aspect, the air spring assembly is provided with a damper coaxially configured with the assembly. In another aspect, the air spring assembly includes a piston spring configured with the primary air volume chamber. Various values of desired spring rates for optimum performance—control, safety and comfort—can be achieved by changing the difference in the air pressures of the two chambers and in the spring assembly.

### TECHNICAL FIELD

The present disclosure relates generally to the technical field of air springs. In particular, it pertains to a dual volume air spring assembly and system to support load, and isolate vibrations, and shocks in a vehicle, and at other places such as machine foundation, building, and the like where a spring action is required. Further, it also pertains to a method for adjusting a spring rate of an air spring assembly.

### BACKGROUND

To isolate the passenger and freight of the vehicle from unwanted forces due to road undulations, bumps, pot holes, etc. various types of mechanical springs like coil springs, leaf springs, and links are used mostly in the vehicles. However, air springs are used in higher-end vehicles to have a smoother ride. The air springs provide an optimum spring rate for a particular load and a particular suspension height combination only. The known air springs do not provide optimum spring rates for various combinations of different loads and suspension heights. For better ride quality, comfort, handling, and safety, it is desirable to have an optimum spring rate for each combination of load and height of the suspension.

Air bags are generally used as air springs in vehicles but when suspension height is less, the required spring rate is less but the airbags provide higher spring rates, and when suspension height is more, the required spring rate is higher but the airbags provide less spring rates. Hence, there is a need for an air spring assembly and system to provide the desired value of spring rates for different conditions and loads. Further, a disadvantage of such airbags is that they are not efficient to deal with forces during turning, braking, and accelerating as large deflections take place which affects the safety of the vehicle. Also, the requirement is not fulfilled by airbags to provide optimal performance for different load conditions, road conditions, and air suspension heights.

Patent document U.S. Pat. No. 6,386,525B1 disclosed a dual volume air spring for truck suspensions including an airbag chamber providing a variable volume and a fixed volume chamber. The chambers are interconnected by a closable orifice. The air bag is provided with a post-like orifice closer which is pushed into the orifice when the air bag is sufficiently compressed and withdrawn from the orifice when the air bag is not compressed. In normal operation, the orifice is open and the combined volumes of the chambers are available resulting in a low spring rate. The orifice closer has an orifice closing portion which is relatively pliant and a rigid or semi-rigid portion which acts as a bump-stop when the pliant portion is substantially completely compressed. When the orifice is completely closed the spring has a high spring rate.

Another Patent document U.S. Pat. No. 7,156,382B2 discloses an air spring assembly that includes a primary airbag mounted to a piston airbag such that the piston airbag provides a rolling surface for the primary airbag. A change in piston airbag pressure changes the effective rate of the primary air spring. A relatively small change in the piston airbag volume provides a change in the spring rate of air spring assembly as the diameter of the roll-off surface is selectively modified.

While the cited references disclose different types of air spring assemblies providing optimum spring rate for a particular load and a particular suspension height, they are not able to provide optimum spring rate for various combinations of different loads and suspension heights, there are no teachings in the cited references that indicate that the disclosed arrangements can enable the control, stability, safety, and comfort of the passengers in the vehicle by providing optimum spring rate for various combinations of different loads and suspension heights. In the cited reference U.S. Pat. No. 7,156,382B2, an effort is made to achieve this objective, however, it is very difficult to predict and control the diameter of the piston airbag and hence, the spring rate during the compression and expansion cycle. Also, this air spring assembly is not durable due to roll-off surface.

There is, therefore, a need to provide a simple, durable, and cost-effective solution that can eliminate the above-mentioned problems of a conventional air spring assembly where control, stability, safety, and comfort to the passengers in the vehicle is ascertained by providing optimum spring rate for various combinations of different loads and suspension heights.

### OBJECTS OF THE INVENTION

A general object of the present disclosure is to provide an air spring assembly that can give different values of spring rates for different combinations of loading conditions, road conditions, and suspension heights.

An object of the present disclosure is to provide a simple, durable, and cost-efficient solution.

Another object of the present disclosure is to provide better control, safety, and comfort to a passenger in the vehicle.

Another object of the present disclosure is to provide an air spring assembly that can be provided with a damper unit coaxially.

Another object of the present disclosure is to provide light in weight, efficient, air spring assembly and a system that can be easily implemented in vehicles.

Another object of the present disclosure is to provide a simple and efficient method for adjusting spring characteristics including at least a spring rate of an air spring assembly.

### SUMMARY

Aspect of the present disclosure relates generally to the technical field of air springs. In particular, it pertains to a dual volume air spring assembly and system to support load, and isolate vibrations, and shocks in a vehicle, and at other places such as machine foundation, building, and the like where a spring action is required. Further, it also pertains to a method for adjusting a spring rate of an air spring assembly.

In an aspect, the present disclosure discloses an air spring assembly for a vehicle. The air spring assembly comprises a first member at one end and a second member at an opposite end. The air spring assembly further comprises a deflectable diaphragm configured to at least partially define a primary air volume chamber and at least partially define a secondary air volume chamber. The primary air volume chamber is provided with a first inlet for charging air therewithin and the secondary air volume chamber is provided with a second inlet for charging air therewithin. The deflectable diaphragm separates the primary air volume chamber and the secondary air volume chamber such that a change in air pressure difference created between the primary air volume chamber and the secondary air volume chamber causes a deflection of the deflectable diaphragm.

In an aspect, the air spring assembly comprises a damper unit configured with the primary air volume chamber and remains at least partially inside the air spring assembly. A first end of the damper unit is adapted to be coupled to one part of a vehicle along with the first member and a second end of the damper unit is adapted to be coupled to another part of the vehicle along with the second member such that when a load is put over the vehicle, a piston rod associated with the damper unit correspondingly moves from an extended position to a compressed position along with the air spring assembly.

In another aspect, the air spring assembly comprises a damper unit configured with the primary air volume chamber and remains completely inside the air spring assembly. A first end of the damper unit is adapted to be coupled to one part of a vehicle along with the first member and a second end of the damper unit is adapted to be coupled to another part of the vehicle along with the second member such that when a load is put over the vehicle, a piston rod associated with the damper unit correspondingly moves from an extended position to a compressed position along with the air spring assembly.

In an aspect, the primary air volume chamber is defined by an inner surface of the first member and an inner surface of the second member, an inner surface of a flexible wall member, and an inner surface of the deflected diaphragm.

In an aspect, the secondary air volume chamber is defined by an inner surface of the first member and an outer surface of the deflectable diaphragm.

In an aspect, the deflectable diaphragm remains in a first position when the air pressure inside the primary air volume chamber and the secondary air volume chamber are equal. Further, the deflectable diaphragm deflects to one or more second positions when there is a change in the air pressure difference between the primary air volume chamber and the secondary air volume chamber.

In an aspect, the air spring assembly comprises a plurality of sensors configured with the air spring assembly to monitor one or more operational parameters of the air spring assembly and correspondingly transmit the monitored operational parameters to an electronic control unit of the vehicle.

In another aspect, the present disclosure discloses an air spring assembly for a vehicle. The air spring assembly comprises a first member at one end and a second member at an opposite end. Further, the air spring assembly further comprises a primary air volume chamber and a secondary air volume chamber. A piston spring is configured to be fitted to one part of the vehicle with a support where the piston spring comprises a cylinder, and a piston rod movably configured within the piston and hermetically sealed with the cylinder by a sealing member. The cylinder comprises at least one passage for permitting air flow between the cylinder and the primary air volume chamber. The air spring assembly further comprises a deflectable diaphragm configured to at least partially define the primary air volume chamber and at least partially define the secondary air volume chamber. The primary air volume chamber is provided with a first passage for inlet and outlet of air and the secondary air volume chamber is provided with a second passage for inlet and outlet of air. A change inair pressure difference created between the primary air volume chamber and the secondary air volume chamber causes a deflection of the deflectable diaphragm. The piston rod moves from an extended position to a compressed position and the deflection diaphragm deflects from a first position to a second position due to a change in air pressure difference created between the primary air volume chamber and the secondary air volume chamber.

In an aspect, at least a flexible wall member defines at least a portion of the primary air volume chamber.

In an aspect, at least a piston spring defines at least a portion of the primary air volume chamber. Further, at least a passage in the air cylinder of the piston spring fluidly connects the cylinder to the primary air volume chamber.

In another aspect, the present disclosure discloses an air spring system comprising at least one air spring assembly, and a plurality of vehicle sensors configured to measure a plurality of vehicle characteristics and correspondingly generate a plurality of sensor signals giving information of one or more of many vehicle characteristics including but not limited to vehicle load, height of suspension, cornering, braking, accelerating, yaw rate, turning, etc. The air spring assembly further comprises a valve assembly configured to control air supply into and out of the at least one air spring assembly, and a control unit operatively coupled to the plurality of sensors and the valve assembly. The control unit is configured to receive the plurality of sensor signals from the plurality of vehicle sensors, analyze the received sensor signals to determine desired spring characteristics including at least a spring rate for the vehicle, and generate an output signal to actuate the valve assembly to modify pressure and/or volume within at least one of the primary air volume chamber and the secondary air volume chamber to achieve the desired spring characteristics in the vehicle.

In yet another aspect, the present disclosure discloses a method of adjusting a the spring characteristics including at least a spring rate of an air spring assembly. The method comprises the steps of providing a primary air volume chamber adjacent to a secondary air volume chamber along with a deflectable diaphragm which at least partially defines the primary air volume chamber and at least partially defines the secondary air volume chamber. The method further comprises the steps of changing a pressure within or volume of any or a combination of the primary air volume chamber and the secondary air volume chamber to change the spring characteristics including at least the spring rate of the air spring assembly.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates an exemplary sectional view of a first embodiment of the proposed dual volume air spring assembly in accordance with embodiments of the present disclosure.

FIG. 2 illustrates an exemplary sectional and side elevation view of the proposed air spring assembly of FIG. 1.

FIG. 3 illustrates an exemplary sectional view of the proposed air spring assembly with a damper unit partially inside the air spring assembly, in accordance with embodiments of the present disclosure.

FIG. 4 illustrates an exemplary sectional view of the disclosed air spring assembly with a damper unit completely inside the air spring assembly, in accordance with embodiments of the present disclosure.

FIG. 5 illustrates an exemplary sectional view of a second embodiment of the proposed air spring assembly having a piston spring, in accordance with embodiments of the present disclosure.

FIG. 6 illustrates exemplary steps involved in a method for adjusting a spring rate of an air spring assembly, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments explained herein relate generally to the technical field of air spring systems. In particular, it pertains to a dual volume air spring assembly and system to support load, and isolate vibrations, and shocks in a vehicle, and at other places such as machine foundation, building, and the like where a spring action is required. Further, it also pertains to a method for adjusting a spring rate of an air spring assembly.

In an aspect, the proposed air spring assembly “assembly” and air spring system “system” for a vehicle are disclosed. The assembly and system include a first member, a second member, a deflectable diaphragm configured to at least partially define a primary air volume chamber and at least partially define a secondary air volume chamber. The deflectable diaphragm is adapted to deflect from a first position to a second position due to a change in air pressure difference created between the primary air volume chamber and the secondary air volume chamber due to one or more amounts of load put on the vehicle, which correspondingly moves the air spring assembly and system from an extended position to a compressed position, thereby adjusting the spring rate. In an embodiment, a damper unit is configured with the primary air volume chamber and remains partially inside the air spring assembly. In another aspect, a damper unit is configured with the primary air volume chamber and remains completely inside the air spring assembly.

In another aspect, the air spring assembly with a piston spring is disclosed. The piston spring is configured with the primary air volume chamber and the air spring assembly along with the piston spring provides stability, springing action to bear loads, and cushioning against shocks.

In yet another aspect, a method for adjusting spring characteristics including at least a spring rate of an air spring assembly is disclosed. The method includes steps of providing a primary air volume chamber adjacent to a secondary air volume chamber along with a deflectable diaphragm which at least partially defines the primary air volume chamber and at least partially defines the secondary air volume chamber in the spring assembly. The method further includes steps of changing a pressure within or a volume of any or a combination of the primary air volume chamber and the secondary air volume chamber to change the spring characteristics including at least the spring rate of the air spring assembly.

While various embodiments of the present disclosure have been elaborated for implementation of the air spring assembly 300 for air suspension of a vehicle, however, those skilled in the art would appreciate that air spring assembly 300 is also equally configurable to be used with machines, buildings, and other structures where a spring action is required, and all such embodiments are well within the scope of the present disclosure without any limitations. Further, the number of air spring assemblies 300 implemented in a vehicle, buildings, machines, or other structures, may be varied based on the spring action required and the loading requirements, thereby forming an air spring system

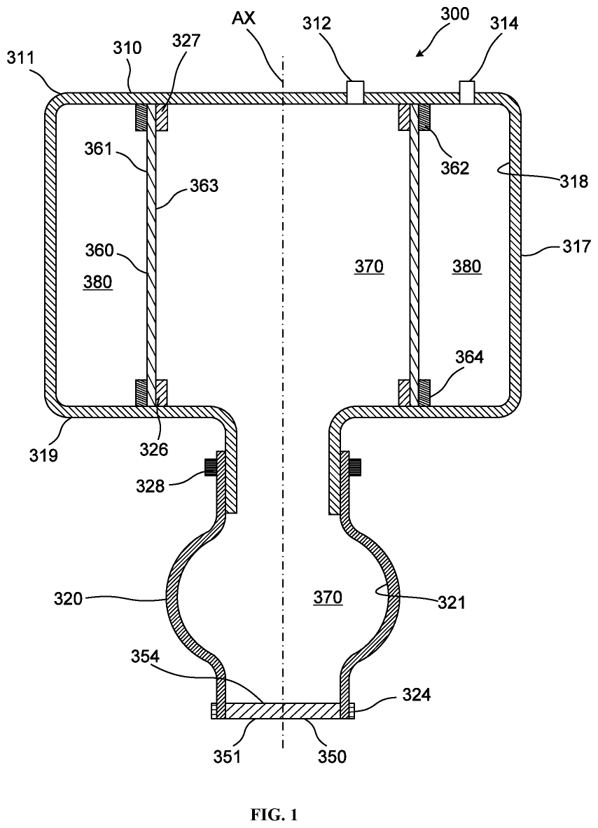

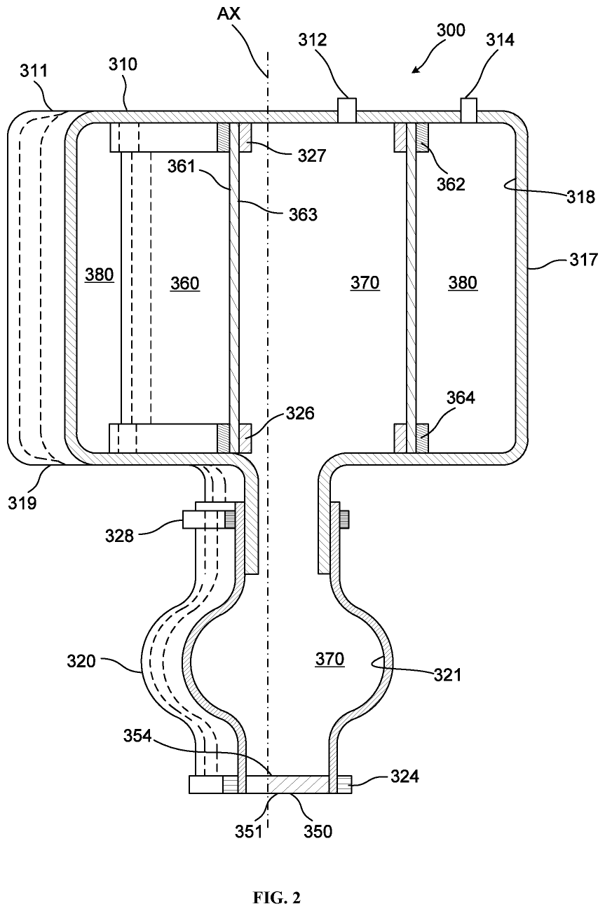

Referring to FIGS. 1 and 2, an exemplary sectional view, and an exemplary sectional view, and a side elevational view of a first embodiment of the disclosed air spring assembly 300 for a vehicle are shown respectively. The air spring assembly 300 includes a first member 310 at a first end and a second member 350 at the opposite second end 351. Further, the air spring assembly 300 includes a deflectable diaphragm 360 configured to at least partially define a primary air volume chamber 370 and at least partially define a secondary air volume chamber 380 in the air spring assembly 300. The primary air volume chamber 370 and the secondary air volume chamber 380 are configured co-axially about an axis (AX). The first member 310 and the second member 350 of the air spring assembly 300 are fixed by welding or bolting or any other suitable mechanism to an axle/wheel on one end and the chassis/subframe of the vehicle on the opposite end.

In an embodiment, the air spring assembly 300 includes a flexible wall member 320 which functions like an airbag during the operation of the air spring assembly 300. The deflectable diaphragm 360 separates the primary air volume chamber 370 and the secondary air volume chamber 380. The primary air volume chamber 370 is defined by an inner surface 318 of the first member 310 and an inner surface 354 of the second member 350 and an inner surface 321 of the flexible wall member 320 and an inner surface 363 of the deflected diaphragm 360, and the secondary air volume chamber 380 is defined by the inner surface 318 of the first member 310 and an outer surface 361 of the deflectable diaphragm 360.

In an embodiment, the flexible wall member 320 and the deflectable diaphragm 360 are hermetically sealed by a plurality of bands. The deflectable diaphragm 360 is hermetically sealed with the first member 310 by a band 327 and another band 362 on the first end 311, and it is also hermetically sealed with the first member 310 by a band 326 and another band 364 on a middle end 319. The flexible wall member 320 is hermetically sealed by a band 328 with the first member 310 and with the second member 350 by a band 324.

Those skilled in the art would understand that alternatively other suitable attachment methods may be used in place of bands to secure the first and second members with the flexible wall member 320 and with deflectable diaphragm 360, as well as for other couplings. Moreover, the primary air volume chamber 370 and the secondary air volume chamber 380 can also be constructed or defined in many other ways, and all such embodiments are also well within the scope of the present disclosure.

In an embodiment, the deflectable diaphragm 360 deflects towards the secondary air volume chamber 380 based on a change in air pressure difference created between the primary air volume chamber 370 and the secondary air volume chamber 380 due to an amount of load put on the vehicle, which forces the air spring assembly 300 to move between an extended position and a compressed position. Upon putting a load on air spring assembly 300 of the vehicle, the deflection diaphragm 360 deflects from a first position to a second position. The deflectable diaphragm 360 comes back to its first position when the load from the air spring assembly 300 is removed.

The deflectable diaphragm 360 deflects towards the primary air volume chamber 370 or towards the secondary air volume chamber 380 whichever has less pressure comparatively. A higher pressure difference between the primary air volume chamber 370 and the secondary air volume chamber 380 may deflect the deflectable diaphragm 360 more in some of the embodiments. When the pressure of the secondary air volume chamber 380 is higher or substantially higher than that of the primary air volume chamber 370, a higher or substantially higher spring rate is achieved respectively. Further, when the pressure of the secondary air volume chamber 380 is lower or substantially lower than that of the primary air volume chamber 370, comparatively lower or substantially lower spring rate is achieved. Accordingly, a desired spring rate can be achieved in the spring assembly 300 by changing the difference in the pressures of the two chambers 370, and 380.

In an embodiment, at a lower height of the suspension, a comparatively higher spring rate is achieved by having much higher pressure in the secondary air volume chamber 380 in comparison to the primary air volume chamber 370. Thus, the higher pressure difference between chambers 370, and 380 may result in a higher spring rate. Further, at a lower height of the suspension, a comparatively lower spring rate is achieved by having less pressure in the secondary air volume chamber 380 in comparison to the primary air volume chamber 370. Thus, the higher pressure difference between chambers 370, and 380 may result in a lower spring rate.

Furthermore, at more height of the suspension, a comparatively higher spring rate is achieved by having much higher pressure in the secondary air volume chamber 380 in comparison to the primary air volume chamber 370. Thus, the higher pressure difference between chambers 370, and 380 may result in a higher spring rate. Moreover, at more height of the suspension, a comparatively lower spring rate is achieved by having less pressure in the secondary air volume chamber 380 in comparison to the primary air volume chamber 370. Thus, the higher pressure difference between chambers 370, and 380 may result in a lower spring rate.

In an embodiment, spring rates of compression and extension of the air spring assembly 300 may be made different by changing the pressures of the primary air volume chamber 370 and/or the secondary air volume chamber 380 during the compression cycle and the extension cycle respectively. Various spring rates are achieved by having a combination of various values of pressures in the primary air volume chamber 370 along with various values of pressures in the secondary air volume chamber 380. Small changes in the quantum of the pressure difference of two chambers 370 and 380 result in rapid changes in the spring rates of the air spring assembly 300. Hence, the air spring assembly 300 gives faster response to active suspension system.

In an embodiment, each primary air volume chamber 370 and the secondary air volume chamber 380 is provided with a pair of inlets or passages 312 and 314 for charging air, where one inlet 312 is to charge air to the primary air volume chamber 370 and second inlet 314 is to charge air to the secondary air volume chamber 380. In an embodiment, a valve assembly comprising control valves can be configured along with the pair of inlets 312 and 314 to control the supply and release of air from these chambers 370, and 380. Skilled in the art can understand that the chambers 370 and 380 may be charged to same or different air pressures through the inlets 312 and 314 respectively.

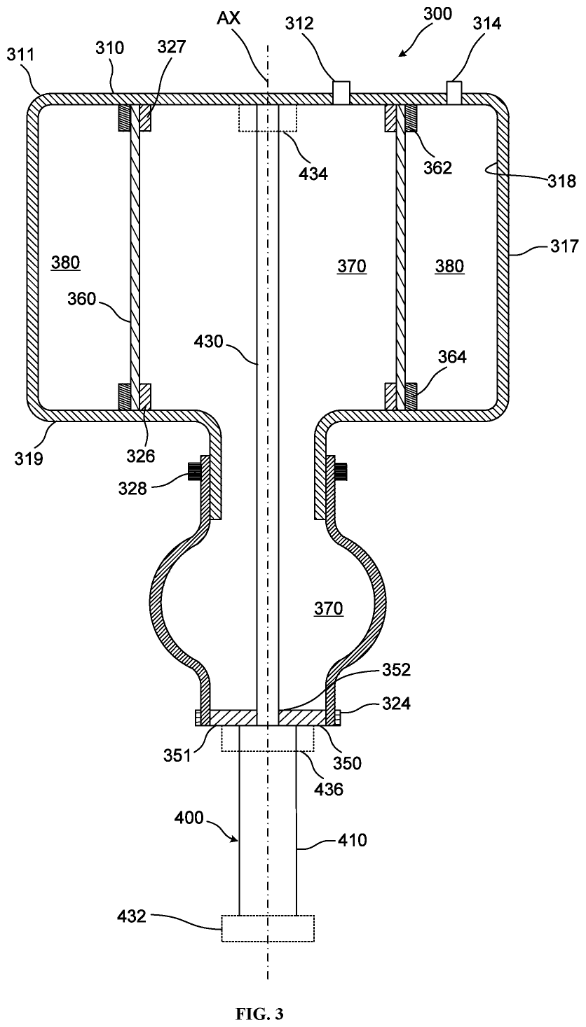

Referring to FIG. 3, in an embodiment, the proposed air spring assembly 300 with a damper unit 400 partially inside the primary air volume chamber 370 of the air spring assembly 300 is disclosed. The damper unit 400 includes a cylinder 410, and remains partially inside the air spring assembly 300, and a piston rod 430 that moves from an extended position to a compressed position along with the air spring assembly 300.

The damper unit 400 can be fitted with a support 432 to one part of the vehicle which may be the axle/wheel or chassis. The cylinder 410 of the damper unit 400 can be fitted to the second member 350 with a support 436. The piston rod 430 of the damper unit 400 goes inside the air spring through an opening 352 in the second member 350 duly hermetically sealed. The piston rod 430 can be fitted to the first member 310 of the air spring with a support 434 at the first end 311.

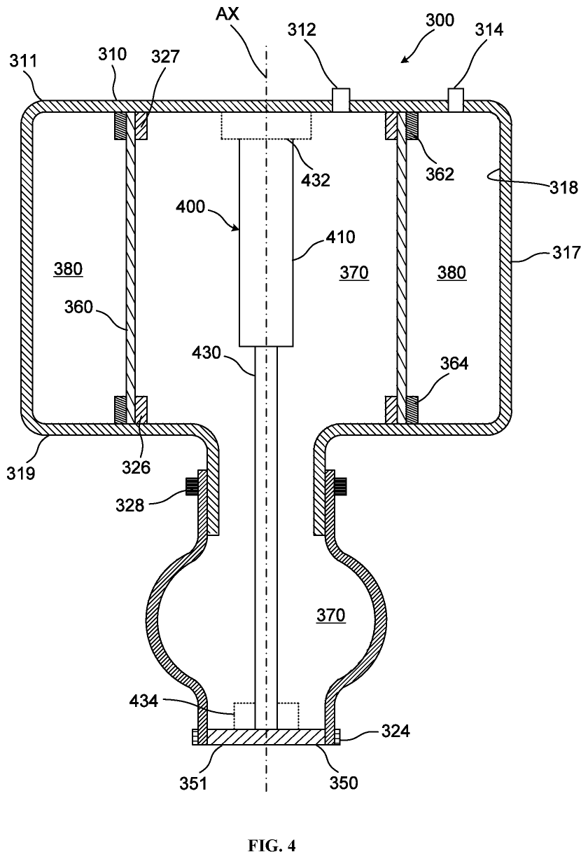

Referring to FIG. 4, in another embodiment, the damper unit 400 can be completely inside the primary air volume chamber 370 of the air spring assembly 300. The cylinder 410 of the damper unit 400 can be fitted to the first member 310 with a support 432 at the first end 311. The piston rod 430 can be fitted to the second member 350 of the air spring with a support 434.

In an embodiment, the first member 310 and the second member 350 of the air spring assembly 300 are fixed by welding or bolting or any other suitable mechanism to the axle/wheel on one end and chassis/subframe of the vehicle on the opposite end. Also, the primary air volume chamber 370 and the secondary air volume chamber 380 may be of any suitable shape, size, and/or configuration. The secondary air volume chamber 380 may be placed anywhere with respect to the primary air volume chamber 370 i.e., outside, inside, partly inside, adjacent, far away, etc. However, the closer placement can give a faster response. It may be understood by those having ordinary skill in the art that the secondary air volume chamber 380 need not be co-axial with the primary air volume chamber 370.

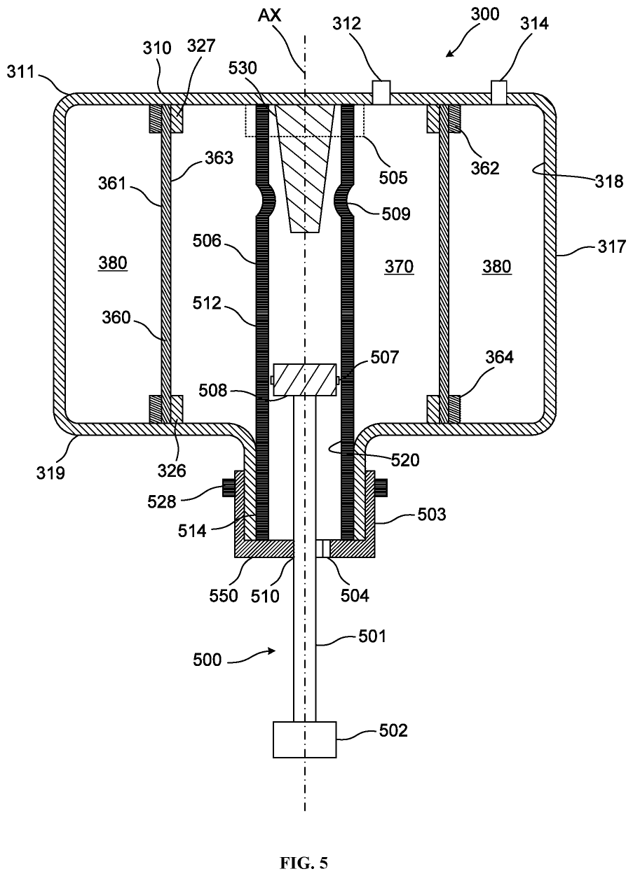

Referring to FIG. 5, a sectional view of a second embodiment of the proposed air spring assembly having a piston spring is disclosed. The embodiment of spring assembly 300 in FIG. 5 is similar to the air spring assembly 300 except for some changes explained hereinafter. The flexible wall member 320 is not required in the air spring assembly 300 of the second embodiment. The air spring assembly 300 includes a piston air spring 500 configured with the primary air volume chamber 370. The piston spring 500 can be fitted with a support 502 to one part of the vehicle which can be a wheel/axle or chassis on one end. A cylinder 506 of the piston spring 500 can be fitted to the first member 310 of the air spring 300 with a support 505 at the first end 311. A piston rod 501 of the piston spring 500 goes inside the air spring 300 through an opening 510 in a second member 503 at an opposite second end 550. The piston rod 501 has a piston 508 which moves inside cylinder 506 along its inner surface 520 and is hermetically sealed with it by a sealing member 507. The cylinder 506 is hermetically sealed with the first member 310 by a sealant 514 at the middle end 319.

In an embodiment, the second member 503 has an air vent 504. The second member 503 is fitted with the first member 310 through a band 528. A primary air volume chamber 370 is defined by an inner surface 318 of the first member 310 and the inner surface 363 of the deflectable diaphragm 360 and the inner surface 520 of the cylinder 506 between the piston 508 and the first end 311 of the first member 310. The cylinder 506 has at least one passage 509 for permitting air flow in or out of the cylinder 506 within the primary air volume chamber 370. The piston spring 500 has a stopper 530 suitably fitted to the first member 310 at the first end 311.

In an embodiment, when a load is put over the vehicle configured with the air spring assembly 300 of FIG. 5, the piston rod 501 of the piston spring 500 moves from an extended position to a compressed position, and the deflectable diaphragm 360 deflects from a first position to a second position. Further, the piston rod 501 of the piston spring 500 moves back to the extended position and the deflectable diaphragm 360 moves back to the first position when the load is removed from the vehicle.

It can be understood that in the above-disclosed embodiments of the present disclosure, the deflectable diaphragm 360 deflects towards the chamber 380 if the pressure of the chamber 370 increases with respect to the pressure of the chamber 380. Similarly, the deflectable diaphragm 360 deflects towards the chamber 370 if the pressure of the chamber 380 increases with respect to the pressure of the chamber 370.

Those skilled in the art would appreciate that the air spring assembly 300 bears the complete load of the axle in the vehicle and provides stability to the vehicle. The air spring assembly along with the piston spring 500 provides springing action to bear loads and cushion shocks.

In an embodiment, the air spring assembly 300 of FIGS. 1 to 5 may include a plurality of sensors (not shown) to monitor and transmit one or more operational parameters of the air spring assembly 300 and the vehicle to an electronic control unit (not shown) of the vehicle. The sensors may be selected from a pressure sensor where at least one pressure sensor each can be fitted inside the primary air volume chamber 370 and/or the secondary air volume chamber 380 to monitor and provide the details of the pressures in the primary air volume chamber 370 and the secondary air volume chamber 380. A position sensor (not shown) may be fitted to indicate the position of the deflectable diaphragm 360, and a height sensor (not shown) may be fitted to indicate the height of the suspension.

In an embodiment, a valve assembly comprising control valves can be configured along with the pair of inlets 312 and 314 to control the supply and release of air from these chambers 370, and 380. Further, a valve can also be configured with the air vent 504 of the second member 503 in FIG. 5. Furthermore, another valve can be configured at the passage 509 of the cylinder 506 for permitting and controlling the airflow in or out of the cylinder 506 within the primary air volume chamber 370.

In an embodiment, the air spring assembly 300 of FIGS. 1 to 5 may include a control unit operatively coupled to the plurality of sensors and the valve assembly. The control unit may be an Electronic Control Unit (ECU) of the vehicle, however, the control unit may also be different from the ECU as well when the spring unit is implemented for non-vehicular operations. The control unit is configured to receive the plurality of sensor signals from the plurality of vehicle sensors and analyze the received sensor signals to determine desirable spring characteristics including at least the spring rate for the vehicle. The control unit accordingly generates and transmits an output signal to actuate the valve assembly to modify pressure and/or volume within at least one of the primary air volume chamber 370 and the secondary air volume chamber 380 to achieve the desired spring characteristics in the vehicle.

In an embodiment, the material of construction of the deflectable diaphragm 360 in FIGS. 1 to 5 is an extensible material such as a rubber tube material of a vehicle tyre but is not limited to the like. The deflectable diaphragm can be constructed as any or a combination of extensible and non-extensible materials. Further, the first member 310 is taken as a rigid member and selected from a metal, plastic, or any other suitable material or combination of the materials. However, it may be understood by those having ordinary skill in the art that it may function in a similar way if it is made partly or completely of flexible/semi-flexible/rigid materials or a combination thereof.

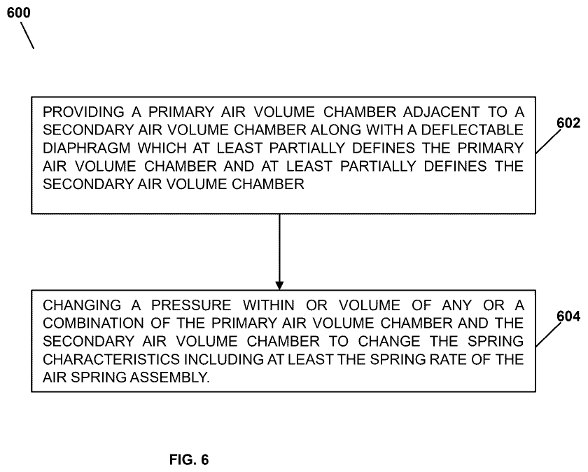

Referring to FIG. 6, a method 600 for adjusting the spring characteristics including at least the spring rate of the air spring assembly 300 of FIGS. 1 to 5 is disclosed. Method 600 includes step 602 of providing a primary air volume chamber 370 adjacent to a secondary air volume chamber 380 along with a deflectable diaphragm 360 that at least partially defines the primary air volume chamber 370 and at least partially defines the secondary air volume chamber 380 in the spring assembly 300. Method 600 further includes step 604 of changing the pressure and/or volume within any or a combination of the primary air volume chamber 370 and the secondary air volume chamber 380 to change spring characteristics including but not limited to the spring rate of the air spring assembly.

Thus, the present disclosure provides an improved, simple, and cost-effective air spring that provides control, stability, safety, and comfort to the passengers in the vehicle by providing optimum spring rates for various combinations of different loads and suspension heights. Some of the preferred embodiments of this disclosure have been disclosed though a worker of ordinary skill in the art would recognize that certain modifications would come within the scope of this invention.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure provides an air spring assembly that can give different values of spring rates for different combinations of loading conditions, road conditions, and suspension heights.

The present disclosure provides a simple, durable, and cost-efficient solution.

The present disclosure provides better control, safety, and comfort to a passenger in the vehicle.

The present disclosure provides an air spring assembly that can be provided with a damper unit coaxially.

The present disclosure provides light in weight, efficient, air spring assembly and a system that can be easily implemented in vehicles.

The present disclosure provides a simple and efficient method for adjusting a spring rate of an air spring assembly.

The present disclosure provides faster response to semi-active/active suspension system.

1. An air spring assembly for a vehicle, the air spring assembly comprising:
a first member at one end and a second member at an opposite end; and
a deflectable diaphragm configured to at least partially define a primary air volume chamber and at least partially define a secondary air volume chamber, wherein the primary air volume chamber is provided with a first inlet for charging air therewithin and the secondary air volume chamber is provided with a second inlet for charging air therewithin:
wherein the deflectable diaphragm separates the primary air volume chamber and the secondary air volume chamber such that a change of air pressure difference created between the primary air volume chamber and the secondary air volume chamber causes a deflection of the deflectable diaphragm.

2. The air spring assembly as claimed in claim 1, wherein the air spring assembly comprises a damper unit configured with the primary air volume chamber remains at least partially inside the air spring assembly, wherein a first end of the damper unit is adapted to be coupled to one part of a vehicle along with the first member and a second end of the damper unit is adapted to be coupled to another part of the vehicle along with the second member such that when a load is put over the vehicle, a piston rod associated with the damper unit correspondingly moves from an extended position to a compressed position along with the air spring assembly.

3. The air spring assembly as claimed in claim 1, wherein the air spring assembly comprises a damper unit configured with the primary air volume chamber remains completely inside the air spring assembly, wherein a first end of the damper unit is adapted to be coupled to one part of a vehicle along with the first member and a second end of the damper unit is adapted to be coupled to another part of the vehicle along with the second member such that when a load is put over the vehicle, a piston rod associated with the damper unit correspondingly moves from an extended position to a compressed position along with the air spring assembly.

4. The air spring assembly as claimed in claim 1, wherein at least a flexible wall member defines at least a portion of the primary air volume chamber.

5. The air spring assembly as claimed in claim 1, wherein the primary air volume chamber is defined by an inner surface of the first member and an inner surface of the second member, an inner surface of a flexible wall member, and an inner surface of the deflected diaphragm, and wherein the secondary air volume chamber is defined by an inner surface of the first member and an outer surface of the deflectable diaphragm.

6. The air spring assembly as claimed in claim 1, wherein the deflectable diaphragm remains in a first position when the air pressure inside the primary air volume chamber and the secondary air volume chamber is equal, and wherein the deflectable diaphragm deflects to one or more second positions when there is a change in air pressure difference between the primary air volume chamber and the secondary air volume chamber.

7. The air spring assembly as claimed in claim 1, wherein the air spring assembly comprises a plurality of sensors configured with the air spring assembly to monitor one or more operational parameters of the air spring assembly and correspondingly transmit the monitored operational parameters to an electronic control unit of the vehicle.

8. The air spring assembly as claimed in claim 1, wherein the air spring assembly further comprises:
a piston spring configured to be fitted to one part of the vehicle with a support, wherein the piston spring comprises a cylinder, and a piston rod movably configured with a piston and hermetically sealed with the cylinder, wherein the cylinder comprises at least one passage for permitting air flow in or out of the cylinder within the primary air volume chamber; and
wherein the piston rod moves from an extended position to a compressed position and the deflection diaphragm deflects from a first position to a second position due to the change in air pressure difference created between the primary air volume chamber and the secondary air volume chamber.

9. An air spring system comprising:
at least one air spring assembly;
a plurality of vehicle sensors configured to measure a plurality of vehicle characteristics and correspondingly generate a plurality of sensor signals;
a valve assembly configured to control air supply into and out of the at least one air spring assembly; and
a control unit operatively coupled to the plurality of sensors and the valve assembly, wherein the control unit is configured to:
receive the plurality of sensor signals from the plurality of vehicle sensors;
analyze the received sensor signals to determine desired spring characteristics including at least a spring rate for the vehicle; and
generate an output signal to actuate the valve assembly to modify pressure and/or volume within at least one of the primary air volume chamber and the secondary air volume chamber to achieve the desired spring characteristics including at least a spring rate in the vehicle.

10. A method of adjusting spring characteristics including at least a spring rate of an air spring assembly, the method comprising the steps of:
providing a primary air volume chamber adjacent to a secondary air volume chamber along with a deflectable diaphragm which at least partially defines the primary air volume chamber and at least partially defines the secondary air volume chamber; and
changing a pressure within or volume of any or a combination of the primary air volume chamber and the secondary air volume chamber to change the spring characteristics including at least the spring rate of the air spring assembly.

11. The air spring assembly as claimed in claim 4, wherein the primary air volume chamber is defined by an inner surface of the first member and an inner surface of the second member, an inner surface of a flexible wall member, and an inner surface of the deflected diaphragm, and wherein the secondary air volume chamber is defined by an inner surface of the first member and an outer surface of the deflectable diaphragm.
